(19) United States
(12) Patent Application Publication
(10) Pub. No.: US 2007/0141250 A1
(43) Pub. Date: Jun. 21, 2007

(54) Liquid Silicone Rubber Composition For Textile Coating

(75) Inventor: Wang-Ping Mei, Taipei (TW)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: DOW CORNING TAIWAN, INC., Taipei (TW)

(21) Appl. No.: 11/538,169

(22) Filed: Oct. 3, 2006

(30) Foreign Application Priority Data
Oct. 4, 2005 (GB) GB 0520145.4

(51) Int. Cl. B05D 7/00

(52) U.S. Cl. 427/213

(57) ABSTRACT

The present invention relates to a liquid silicone rubber composition useful for textile coating, in particular for textile coating by screen-printing. The LSR composition of the present invention shows better film appearance and better physical properties such as softness, low-tackiness, and elongation.

This invention relates to a liquid silicone rubber (LSR) composition useful for textile coating, in particular for textile coating by screen-printing.

Liquid silicone rubber (“LSR”) compositions, which are prior to curing in the form of liquids and after curing forming an elastomeric product are well known in silicone industry. LSR has been attractively used in textile printing applications due to the soft hand feel and washing durability of the resulting treated textiles.

There are many prior art references relating to LSR and its applications. Japanese Patent Publication No. H03-100058 discloses a liquid silicone rubber composition comprising (a) an organopolysiloxane containing at least two silicon-bonded unsaturated radicals, (b) organohydrogenpolysiloxane containing at least three silicon-bonded hydrogen atoms, (c) porous inorganic finely divided powder carrying a liquid material to provide antistatic property, and (d) platinum catalyst. The liquid material exemplifies fluorine-containing surfactant and silicone polyether copolymer. This LSR is useful for a fixing roll.

Japanese Patent Publication No. 2002-302607 (which corresponds to U.S. Pat. No. 6,761,673) discloses a liquid silicone rubber composition comprising alkenyl-containing organopolysiloxane, silicon-bonded hydrogen-containing organohydrogenpolysiloxane, cyclic diorganopolysiloxane containing at least three alkenyl radicals, platinum catalyst, and silica. This LSR is useful for a fixing roll where fluorine-containing resin is applied onto the LSR as top coating.

Japanese Patent Publication No. H09-87585 discloses a liquid silicone rubber composition comprising alkenyl-containing polydiorganosiloxane, organopolysiloxane resin, inorganic filler, organohydrogenpolysiloxane, platinum catalyst, epoxidized-containing organosilicon compound, and organic titanium compound. This LSR is useful for air-bag coatings.

EP0398745 discloses a hydrosilylation cured silicone composition comprising two silicon containing non-ionic surface active agents, one comprising silicon bonded hydrogen atoms or silphatic unsaturated hydrocarbon radicals and the other having a hydrophobic silicone portion and at least one hydrophilic polyol portion. Such compositions are used as a dental impression material.

However, currently available LSRs used to treat textiles tend to provide textiles with a tacky and dissatisfactory film appearance. Whilst this problem can be solved by increasing the viscosity and/or crosslinking density of liquid polydiorganosiloxane, such solutions however cause other problems, in particular they result in compositions which prove difficult to coat onto textile and/or increase stiffness of the resulting coated textiles.

The present invention relates to a liquid silicone rubber (LSR) composition useful for textile coating, in particular for textile coating by screen-printing. The LSR composition of the present invention provides improved film appearance and improved physical properties such as softness, low-tackiness, and elongation.

The present invention provides a liquid silicone rubber (LSR) composition useful for textile coating, which comprises:

(A) 100 parts by weight of a liquid polydiorganosiloxane containing at least two alkenyl radicals in each molecule,

(B) an organohydrogenpolysiloxane containing at least three silicon-bonded hydrogen atoms in each molecule, in an amount that the molar ratio of the total number of the silicon-bonded hydrogen atoms in this ingredient to the total quantity of all alkenyl radicals in ingredient (A) is from 0.5:1 to 20:1,

(C) from 5 to 50 parts by weight of a reinforcing filler, based on the amount of ingredient (A),

(D) from 0.05 to 4.5 parts by weight of a polydiorganosiloxane-polyether copolymer containing from 5 to 50 percent by mole of the polyether, based on 100 parts by weight of the combined weight of ingredients (A), (B), and (C), and

(E) a hydrosilylation catalyst.

Ingredients that may be contained in the LSR composition of the present invention are discussed below:

(A) Liquid Alkenyl-Containing Polydiorganosiloxane

Ingredient (A)is a liquid polydiorganosiloxane containing at least two silicon-bonded alkenyl radicals in each molecule. Suitable alkenyl radicals in ingredient (A) preferably contain from 2 to 10 carbon atoms, preferred example, vinyl, isopropenyl, allyl, and 5-hexenyl. Ingredient (A) preferably additionally comprises silicon-bonded organic groups other than alkenyl radicals. Such silicon-bonded organic groups are typically selected from monovalent saturated hydrocarbon radicals, which preferably contain from 1 to 10 carbon atoms, and monovalent 10 aromatic hydrocarbon radicals, which preferably contain from 6 to 12 carbon atoms, which are unsubstituted or substituted with the groups that do not interfere with curing of this inventive composition, such as halogen atoms. Preferred species of the silicon-bonded organic groups are, for example, alkyl groups such as methyl, ethyl, and propyl; halogenated alkyl groups such as 3,3,3-trifluoropropyl; and aryl groups such as phenyl.

The molecular structure of ingredient (A) is typically linear, however, there can be some branching due to the presence of trivalent siloxane units within the molecule. To achieve a useful level of physical properties in the elastomer prepared by curing the LSR composition of the present invention, the molecular weight of ingredient (A) should be sufficient so that it achieves a viscosity of at least 0.1 Pa·s at 25° C. The upper limit for the molecular weight of ingredient (A) is not specifically restricted and is typically limited only by the processability of the LSR composition of the present invention.

Preferred embodiments of ingredient (A) are polydiorganosiloxanes containing alkenyl radicals at the two terminals and are represented by the general formula (I):
R′R″R′″SiO−(R″R′″SiO)ₘ−SiOR′″R″R′ (I)
In formula (I), each R′ is an alkenyl radical, which preferably contains from 2 to 10 carbon atoms, such as vinyl, allyl, and 5-hexenyl.

R″ does not contain ethylenic unsaturation, Each R″ may be the same or different and is individually selected from monovalent saturated hydrocarbon radical, which preferably contain from 1 to 10 carbon atoms, and monovalent aromatic hydrocarbon radical, which preferably contain from 6 to 12 carbon atoms. R″ may be unsubstituted or substituted with one or more groups that do not interfere with curing of this inventive composition, such as halogen atoms. R′″ is R′ or R″. m represents a degree of polymerization suitable for ingredient (A) to have a viscosity of at least 0.1 Pa·s at 25° C., preferably from 0.1 to 300 Pa·s.

Preferably, all R″ and R′″ groups contained in a compound in accordance with formula (I) are methyl groups. Alternatively at least one R″ and/or R′″ group in a compound in accordance with formula (I) is methyl and the others are phenyl or 3,3,3-trifluoropropyl. This preference is based on the availability of the reactants typically used to prepare the polydiorganosiloxanes (ingredient (A)) and the desired properties for the cured elastomer prepared from compositions comprising such polydiorganosiloxanes.

Preferred examples of ingredient (A) containing ethylenically unsaturated hydrocarbon radicals only in terminal groups include, but are not limited to, dimethylvinylsiloxy-terminated polydimethylsiloxane, dimethylvinylsiloxy-terminated polymethyl-3,3,3-trifluoropropylslioxane, dimethylvinylsiloxy-terminated dimethylsiloxane-3,3,3-trifluoropropylmethylsiloxne copolymer, and dimethylvinylsiloxy-terminated dimethylsiloxane/methylphenylsiloxane copolymer.

Generally, ingredient (A) has a viscosity of at least 0.1 Pa·s at 25° C., preferably from 0.1 to 300 Pa·s. more preferably 0.1 to 100 Pa·s at 20° C.

(B) Organohydrogenpolysiloxane

Ingredient (B) is an organohydrogenpolysiloxane, which operates as a cross-linker for curing ingredient (A), by the addition reaction of the silicon-bonded hydrogen atoms in ingredient (B) with the alkenyl groups in ingredient (A) under the catalytic activity of ingredient (E) to be mentioned below. Ingredient (B) normally contains 3 or more silicon-bonded hydrogen atoms so that the hydrogen atoms of this ingredient can sufficiently react with the alkenyl radicals of ingredient (A) to form a network structure therewith and thereby cure the composition.

The molecular configuration of ingredient (B) is not specifically restricted, and it can be straight chain, branch-containing straight chain, or cyclic. While the molecular weight of this ingredient is not specifically restricted, the viscosity is preferably from 0.001 to 50 Pa·s at 25° C. in order to obtain a good miscibility with ingredient (A).

Ingredient (B) is preferably added in an amount such that the molar ratio of the total number of the silicon-bonded hydrogen atoms in ingredient (B) to the total number of all alkenyl radicals in ingredient (A) is from 0.5:1 to 20:1. When this ratio is less than 0.5:1, a well-cured composition will not be obtained. When the ratio exceeds 20:1, there is a tendency for the hardness of the cured composition to increase when heated.

Examples of ingredient (B) include but are not limited to:

(i) trimethylsiloxy-terminated methylhydrogenpolysiloxane,

(ii) trimethylsiloxy-terminated polydimethylsiloxane-methylhydrogensiloxane,

(iii) dimethylhydrogensiloxy-terminated dimethylsiloxane-methylhydrogensiloxane copolymers,

(iv) dimethylsiloxane-methylhydrogensiloxane cyclic copolymers,

(v) copolymers composed of (CH₃)₂HSiO_{½} units and SiO _{4/2} units, and

(vi) copolymers composed of (CH₃)₃SiO_{½} units, (CH₃)₂HSiO_{½} units, and SiO _{4/2} units.

(C) Reinforcing Filler

To achieve high level of physical properties that characterize some types of cured elastomer that can be prepared using the LSR composition of the present invention, it may be desirable to include a reinforcing filler such as finely divided silica. Silica and other reinforcing fillers are often treated with one or more known filler treating agents to prevent a phenomenon referred to as “creping” or “crepe hardening” during processing of the curable composition.

Finely divided forms of silica are preferred reinforcing fillers. Colloidal silicas are particularly preferred because of their relatively high surface area, which is typically at least 50 square meters per gram. Fillers having surface areas of at least 200 square meters per gram are preferred for use in the present invention. Colloidal silicas can be provided in the form of precipitated or fumed silica. Both types of silica are commercially available.

The amount of finely divided silica or other reinforcing filler used in the LSR composition of the present invention is at least in part determined by the physical properties desired in the cured elastomer. The LSR composition of the present invention typically comprises from 5 to 50 parts, preferably from 10 to 30 parts by weight of a reinforcing filler (e.g., silica), based on the weight of the polydiorganosiloxane (ingredient (A)), preferably 5 to 50 parts and more preferably 10 to 30 parts for every 100 parts of ingredient A.

When the filler is naturally hydrophilic (e.g. untreated silica fillers), it is preferably treated with a treating agent. This may be prior to introduction in the composition or in situ (i.e. in the presence of at least a portion of the other ingredients of the LSR composition of the present invention by blending these ingredients together until the filler is completely treated and uniformly dispersed to for a homogeneous material). Preferably, untreated filler is treated in situ with a treating agent in the presence of ingredient (A).

Preferably the filler is surface treated using for example with a fatty acid or a fatty acid ester such as a stearate, or with organosilanes, polydiorganosiloxanes, or organosilazanes hexaalkyl disilazane or short chain siloxane diols to render the filler(s) hydrophobic and therefore easier to handle and obtain a homogeneous mixture with the other ingredients. The surface treatment of the fillers makes the fillers easily wetted by the silicone polymer. These surface modified fillers do not clump, and can be homogeneously incorporated into the silicone polymer. This results in improved room temperature mechanical properties of the uncured compositions.

Preferably the filler treating agent can be any low molecular weight organosilicon compounds disclosed in the art applicable to prevent creping of organosiloxane compositions during processing.

The treating agents are exemplified but not limited to liquid hydroxyl-terminated polydiorganosiloxane containing an average from 2 to 20 repeating units of diorganosiloxane in each molecule, hexaorganodisiloxane, hexaorganodisilazane, and the like. The hexaorganodisilazane intends to hydrolyze under conditions used to treat the filler to form the organosilicon compounds with hydroxyl groups. Preferably, at least a portion of the silicon-bonded hydrocarbon radicals present in the treating agent are identical to a majority of the hydrocarbon radicals present in ingredients (A) and (B). A small amount of water can be added together with the silica treating agent(s) as processing aid.

It is believed that the treating agents function by reacting with silicon-bonded hydroxyl groups present on the surface of the silica or other filler particles to reduce interaction between these particles.

The filler may be treated with the treating agent prior to formulating, and the treated filler is commercially available.

(D) Polvdiorganosiloxane-Polvether Copolymer

Ingredient (D) is a polydiorganosiloxane-polyether copolymer, which is represented by the general formula (II):
X_{w}R¹_{3-w}SiO(R²R³SiO)_{d}(R⁴XSiO)_{d′}SiR¹_{3-w}X_{w} (II)
(where X is−R⁵−(OC₂H₄)_{y}(OA)_{z}E)
wherein R¹, R², R³, and R⁴ are independently selected from monovalent saturated hydrocarbon radicals, which preferably contain from 1 to 10 carbon atoms, and monovalent aromatic hydrocarbon radicals, which preferably contain from 6 to 12 carbon atoms; E is identical or different and selected from hydroxy, alkoxy preferably containing from 1 to 6 carbon atoms, and carboxyl; A is an alkylene preferably containing from 1 to 6 carbon atoms; R⁵ denotes an alkylene radical preferably containing 2 to 6 carbon atoms; w is an integer of 0, 1, or 2, and must be 1 or 2 when d′ is zero; d is an integer of 0 to 200, and d′ is an integer of 0 to 15, where d and d′ are present in amounts relative to each other such that ingredient (D) contains from 5 to 50 percent by mole of polyether per molecule; y and z are independently integer of 0 to 30, the sum of y and z being in the range from 2 to 50.

R¹, R², R³, and R⁴ are preferably methyl. R⁵ is preferably propylene or iso-butylene. E is preferably hydroxyl, methoxy, or acetoxy. A is preferably propylene, iso-propylene, or butylene.

Ingredient (D) must have from 5 to 50 percent by mole of polyether units. Ingredient (D) is insoluble but can be dispersed in a polydiorganosiloxane fluid (such as ingredients (A) and (B) described above. Ingredient (D) shows a trend of having increasing specific gravity with increasing polyether content.. When ingredient (D) has more than 50 percent by mole of polyether groups, its specific gravity becomes far from that of the polydiorganosiloxane fluid, which causes separation. To maintain stability after mixing, the upper limit of content of polyether is 50 percent by mole, and preferably 30 percent by mole. It is known that the percent by mole of polyether groups may be calculated using the following formula

$$\frac{\begin{matrix}number of siloxane units \\ bonded to polyether groups\end{matrix} \times 100}{total number of siloxane units in the molecule}$$

Ingredient (D) is added in an amount from 0.05 to 4.5 parts by weight, for every 100 parts by weight of the combined weight of ingredients (A), (B), and (C).

(E) Hydrosilylation Catalyst

Curing of the LSR composition of the present invention is catalyzed by ingredient (E), which is a hydrosilylation catalyst that is a metal selected from the platinum group of the periodic table, or a compound of such metal. The metals include platinum, palladium, and rhodium. Platinum and platinum compounds are preferred due to the high activity level of these catalysts in hydrosilylation reaction.

Example of preferred curing catalysts include but are not limited to platinum black, platinum on various solid supports, chloroplatinic acids, alcohol solutions of chloroplatinic acid, and complexes of chloroplatinic acid with liquid ethylenically unsaturated compounds such as olefins and organosiloxanes containing ethylenically unsaturated silicon-bonded hydrocarbon radicals. Complexes of chloroplatinic acid with organosiloxanes containing ethylenically unsaturated hydrocarbon radicals are described in U.S. Pat. No. 3,419,593.

The concentration of ingredient (E) in the LSR composition of the present invention is equivalent to a platinum-group metal concentration from 0.1 to 500 parts by weight of platinum-group metal, per million parts (ppm), based on the combined weight of ingredients (A) and (B).

Mixtures of the aforementioned ingredients (A), (B), and (E) may begin to cure at ambient temperature.

To obtain a longer working time or pot life of the LSR composition of the present invention, a suitable inhibitor can be used in order to retard or suppress the activity of the catalyst. For example, the alkenyl-substituted siloxanes as described in U.S. Pat. No. 3,989,887 may be used. Cyclic methylvinylsiloxanes are preferred.

Another class of known inhibitors of platinum catalysts includes the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C. or above to cure at a practical rate.

Inhibitor concentrations as low as 1 mole of inhibitor per mole of the metal will in some instances impart satisfactory storage stability and cure rate. In other instances inhibitor concentrations of up to 500 moles of inhibitor per mole of the metal are required. The optimum concentration for a given inhibitor in a given composition is readily determined by routine experimentation.

(F) Chain Extender

If desired, the LSR composition of the present invention may comprise ingredient (F), which may be a disiloxane or a low molecular weight polyorganosiloxane containing two silicon-bonded hydrogen atoms at the terminal positions.

When ingredient (F) is a disiloxane, it is represented by the general formula (HR^{a}₂Si)₂O, and when ingredient (F) is a polyorganosiloxane, it has terminal units of the general formula HR^{a}₂SiO_{½} and non-terminal units of the formula R^{b}₂SiO. In these formulae, R^{a} and R^{b} individually represent unsubstituted or substituted monovalent hydrocarbon radicals that are free of ethylenic unsaturation, which include, but are not limited to alkyl groups containing from 1 to 10 carbon atoms, substituted alkyl groups containing from 1 to 10 carbon atoms such as chloromethyl and 3,3,3-trifluoropropyl, cycloalkyl groups containing from 3 to 10 carbon atoms, aryl containing 6 to 10 carbon atoms, alkaryl groups containing 7 to 10 carbon atoms, such as tolyl and xylyl, and aralkyl groups containing 7 to 10 carbon atoms, such as benzyl.

Preferably, ingredient (F) is tetramethyldihydrogendisiloxane or dimethylhydrogen-terminated polydimethylsiloxane.

Ingredient (F) functions as chain extender for ingredient (A). In other words, ingredient (F) reacts with the alkenyl radicals of ingredient (A), thereby linking two or more molecules of ingredient (A) together and increasing its effective molecular weight and the distance between potential cross-linking sites.

Ingredient (F) may be added in an amount from 1 to 10 parts by weight, based on the weight of ingredient (A), preferably 1 to 10 parts per 100 parts of ingredient A.

The effect of the chain extender on the properties of the cured LSR composition is similar to that of using a higher molecular weight polyorganosiloxane, but without the processing and other difficulties associated with high viscosity curable organosiloxane composition.

Chain extenders suitable for use in the present compositions have viscosities from about 0.001 to 1 Pa·s at 25° C., preferably from about 0.001 to 0.1 Pa·s, to maximize the concentration of silicon-bonded hydrogen atoms and minimize the viscosity of the LSR composition of the present invention.

The number of silicon bonded hydrogen groups provided in ingredient (F), when present, and in ingredient (B) is sufficient to provide the degree of crosslinking required to cure the LSR composition of the present invention to the desired physical property. The total quantity of silicon-bonded hydrogen atoms contributed by the crosslinker is such that the molar ratio of silicon bonded hydrogen atoms contributed by both the crosslinker and the chain extender to the vinyl or other alkenyl radicals present in the LSR composition of the present invention is from 0.5 to 20.

(G) Additional Optional Ingredients

The LSR composition of the present invention may contain various optional ingredients that are conventionally utilized in such compositions, such as pigments and/or dyes. Any pigments and dyes, which are applicable to silicone elastomers or coating but do not inhibit the hydrosilylation catalyzed addition reaction, can be employed in this invention. The pigments and dyes include but are not limited to carbon black, titanium dioxide, chromium oxide, bismuth vanadium oxide and the like. In a preferred embodiment of the invention, the pigments and dyes are used in form of pigment master batch composed of them dispersed in the polydiorganosiloxane with a low viscosity (ingredient (A)) at the ratio of 25:75 to 70:30.

The other optional ingredients comprise, for example, non-reinforcing fillers, such as quartz, alumina, mica, and calcium carbonate; adhesion promoters; flame-retardants; and heat and/or ultraviolet light stabilizers.

The composition of the present invention may be prepared by combining all of ingredients at ambient temperature. Any mixing techniques and devices described in the prior art can be used for this purpose. The particular device to be used will be determined by the viscosities of ingredients and the final curable coating composition. Suitable mixers include but are not limited to paddle type mixers and kneader type mixers. Cooling of ingredients during mixing may be desirable to avoid premature curing of the composition.

The order for mixing ingredients is not critical in this invention. Preferably, it is desirable to prepare, at first, two parts, one comprising ingredient (A), some of ingredient (C) and if necessary, the inhibitor for the hydrosilylation catalyst, and the other comprising ingredient (B), the rest of ingredient (C) and if necessary, the inhibitor for the hydrosilylation catalyst, and where ingredient (D) may be added to either of the parts prior to combination of them. Then the two parts are mixed in the presence of ingredient (E) to form the LSR composition of the present invention.

The textile to be coated with the curable coating composition of the present invention includes but is not limited to cotton, polyester, nylon and mixtures thereof together or in combination with other materials such as a mixture of nylon comprising from 2 to 20 percent of an elasticated fiber such as Lycra® (trademark of Du Pont company).

The LSR composition of the present invention may be cured by heating at a temperature from 200 to 400° C. for 3 seconds to a few minutes. To obtain textiles having even better properties, such as with less damage, it is desirable that the LSR composition of the present invention is cured for a few seconds at the above-mentioned temperature, and repeat the heating after it is cooled to room temperature.

In working examples, the following ingredients defined as follows were used:

TABLE I

| | |
|---|---|
| Vi-Siloxane 1 | Vinyl-terminated polydimethylsiloxane having the viscosity of 55 Pa · s at 25° C. |
| Vi-Siloxane 2 | Vinyl-terminated polydimethylsiloxane having the viscosity of 2 Pa · s at 25° C. |
| H-Siloxane 1 | Trimethylsiloxy-terminated polydimethyl-methylhydrogensiloxane containing |
| | 0.12% by weight of hydrogen atom bonded to silicon and the viscosity of |
| | 0.005 Pa · s at 25° C. |
| H-Siloxane 2 | Hydrogendimethylsiloxy-terminated polydimethylsiloxane having the |
| | viscosity of 0.011 Pa · s at 25° C. |
| Inhibitor 1 | Methylvinyl cyclosiloxane (MeViSiO)ₙ (n < 6) |
| Inhibitor 2 | 1-Ethynyl-l-cyclohexanol |
| Silica 1 | Hydrophobic treated fumed silica having the surface area of 225 m²/g |
| Catalyst 1 | A catalyst, which was a solution composed of 0.2 percent by weight of |
| | platinum-siloxane complex prepared from platinum dichloride and 1,3- |
| | divinyltetramethyldisiloxane according to method described in U.S. Pat. No. |
| | 5,175,325, and 98 percent by weight of vinyldimethylsiloxy-terminated |
| | polydimethylsiloxane having the viscosity of 0.19 Pa · s at 25° C. and 1.8 |
| | percent by weight of 1,3-divinyltetramethyldisiloxane, to have platinum |
| | content of 1000 ppm. |

The silicone-polyether copolymer (“SPE”) (ingredient (D)) employed in the working examples were represented by the following formula:
XₘMe₃₋ₘSiO(Me₂SiO)_{D}(MeXSiO)_{D′}SiMe₃₋ₘXₘ

(where X for the sake of these examples was —(CH₂)₃(OCH₂CH₂)ₚ(OCH₂CH(CH₃))_{q}E)

TABLE II

| | Mole % | m | D | D′ | p | Q | E |
|---|---|---|---|---|---|---|---|
| SPE1 | 7.7 | 0 | 22 | 2 | 12 | 0 | OAc |
| SPE2 | 8.3 | 0 | 108 | 10 | 18 | 18 | OAc |
| SPE3 | 13.3 | 1 | 13 | 2 | 12 | 0 | OH |
| SPE4 | 25.7 | 0 | 8.7 | 3.7 | 12 | 0 | OH |
| SPE5 | 33.3 | 0 | 0 | 1 | 7 | 0 | OH |
| SPE6 | 4.3 | 0 | 70 | 3.2 | 0 | 2 | OH |

(wherein the Mole % was of the polyether portion and the Ac was acetyl)

The above ingredients were mixed up in amounts shown in Table III to form homogeneous base compositions. First the fumed silica was placed in a container and mixed with the Vi-Siloxane with low viscosity first, and then other ingredients were added thereto. The SPE was selected from Table II and added to the composition in amount shown in Table IV during mixing procedure.

TABLE III

| | Base Composition |
|---|---|
| Vi-Siloxane 1 | 17.00 |
| Vi-Siloxane 2 | 54.03 |
| H-Siloxane 1 | 1.49 |
| H-Siloxane 2 | 3.43 |
| Inhibitor 1 | 0.07 |
| Inhibitor 2 | 0.06 |
| Silica 1 | 23.92 |
| Total | 100.00 |

Pigment master batch in which white pigment of TiO₂ powder was dispersed in Vi-Siloxane 2 at the ratio of 65:35, was mixed with the base composition. Then platinum catalyst was added to the pigmented composition. The amounts of those ingredients to be added to the base composition were described in Table IV.

Paste coating composition was obtained and coated (printed) onto nylon fabric available for swimming suit with use of knife through a screen. It was cured for 1.5 seconds at a temperature of 400° C. and after pause for 1 minute, cured for another 1.5 seconds at the same temperature.

After curing, fabric having a coated film, applied in an amount of 60 grams per square meter, was evaluated by hand-feeling to determine tackiness or softness, and by repetition of folding to determine elongation. These performances were evaluated on a scale of E (Strongest) to A (Weakest) as shown in Table IV.

TABLE IV

| Run | | | | | | | | | |
|---|---|---|---|---|---|---|---|---|---|
| No. 1 | No. 2 | No. 3 | No. 4 | No. 5 | No. 6 | No. 7 | No. 8 | No. 9 | No. 10 |

Coating Composition (Unit: Parts by Weight)

| | | | | | | | | | | |
|---|---|---|---|---|---|---|---|---|---|---|
| Base composition | 100 | 100 | 100 | 100 | 100 | 100 | 100 | 100 | 100 | 100 |
| Pigment | 5 | 5 | 5 | 5 | 5 | 5 | 5 | 5 | 5 | 5 |
| Catalyst | 5 | 5 | 5 | 5 | 5 | 5 | 5 | 5 | 5 | 5 |
| SPE 1 | 1 | 0.1 | | | | | | | | |
| SPE 2 | | | 1 | 0.1 | | | | | | |
| SPE 3 | | | | | 1 | 0.1 | | | | |
| SPE 4 | | | | | | | 1 | 0.1 | | |
| SPE 5 | | | | | | | | | 1 | 0.1 |
| SPE 6 | | | | | | | | | | |

Coating Film Performances

| | | | | | | | | | | |
|---|---|---|---|---|---|---|---|---|---|---|
| Low Tackiness | E | B | E | E | E | D | E | D | E | A |
| Softness | C | C | C | D | E | E | B | C | B | C |
| Elongation | E | E | C | E | E | E | B | E | A | E |

| Run | | | | | | | | |
|---|---|---|---|---|---|---|---|---|
| No. 11 | No. 12 | No. 13 | No. 14 | No. 15 | No. 16 | No. 17 | No. 18 | No. 19 |

Coating Composition (Unit: Parts by Weight)

| | | | | | | | | | |
|---|---|---|---|---|---|---|---|---|---|
| Base composition | 100 | 100 | 100 | 100 | 100 | 100 | 100 | 100 | 100 |
| Pigment | 5 | 5 | 5 | 5 | 5 | 5 | 5 | 5 | 5 |
| Catalyst | 5 | 5 | 5 | 5 | 5 | 5 | 5 | 5 | 5 |
| SPE 1 | | | | | | | | | |
| SPE 2 | 0.5 | 2 | 3 | | | | | | |
| SPE 3 | | | | 2 | 4 | 5 | | | |
| SPE 4 | | | | | | | | | |
| SPE 5 | | | | | | | | | |
| SPE 6 | | | | | | | 1 | 0.1 | |

Coating Film Performances

| | | | | | | | | | |
|---|---|---|---|---|---|---|---|---|---|
| Low Tackiness | E | E | E | E | E | E | E | A | A |
| Softness | D | B | A | D | B | A | B | C | D |
| Elongation | B | C | D | E | E | E | D | E | E |

Runs No. 16 to No. 18 were for comparison.

1. A liquid silicone rubber composition for textile coating comprising:
(A) 100 parts by weight of a liquid polydiorganosiloxane containing at least two alkenyl radicals in each molecule,
(B) an organohydrogenpolysiloxane containing at least three silicon-bonded hydrogen atoms in each molecule, in an amount that the molar ratio of the total number of the silicon-bonded hydrogen atoms in this ingredient to the total quantity of all alkenyl radicals in ingredient (A) is from 0.5:1 to 20:1,
(C) from 5 to 50 parts by weight of a reinforcing filler, based on the amount of ingredient (A),
(D) from 0.05 to 4.5 parts by weight of a polydiorganosiloxane-polyether copolymer containing from 5 to 50 percent by mole of the polyether, based on 100 parts by weight of the combined weight of ingredients (A), (B), and (C), and
(E) a hydrosilylation catalyst.

2. The liquid silicone rubber composition according to claim 1, characterized in that ingredient (A) is represented by the general formula I:
R′R″R′″SiO−(R″R′″SiO)ₘ−SiOR′″R″R′ I
in which R′ is an alkenyl radical; R″ does not contain ethylenic unsaturation, and is identical or different and individually selected from monovalent saturated hydrocarbon radical and monovalent aromatic hydrocarbon radical; R′″ is R′ or R″; and m represents a degree of polymerization equivalent to that ingredient (A) has a viscosity of at least 0.1 Pa·s at 25° C.

3. The liquid silicone rubber composition according to claim 1, characterized in that ingredient (A) is selected from the group consisting of dimethylvinylsiloxy-terminated polydimethylsiloxane, dimethylvinylsiloxy-terminated polymethyl-3,3,3-trifluoropropylslioxane, dimethylvinylsiloxy-terminated dimethylsiloxane-3,3,3-trifluoropropylmethylsiloxne copolymer, and dimethylvinylsiloxy-terminated dimethylsiloxane/methylphenylsiloxane copolymer.

4. The liquid silicone rubber composition according to any preceding claim 1, characterized in that ingredient (B) is selected from the group consisting of trimethylsiloxy-terminated methylhydrogenpolysiloxane, trimethylsiloxy-terminated polydimethylsiloxane-methylhydrogensiloxane, dimethylhydrogensiloxy-terminated dimethylsiloxane-methylhydrogensiloxane copolymers, dimethylsiloxane-methylhydrogensiloxane cyclic copolymers, copolymers composed of (CH₃)₂HSiO_{½} units and SiO _{4/2} units, and copolymers composed of (CH₃)₃SiO_{½} units, (CH₃)₂HSiO _{½} units and SiO _{4/2} units.

5. The liquid silicone rubber composition according to claim 1, characterized in that ingredient (C) is finely divided silica.

6. The liquid silicone rubber composition according to claim 1, characterized in that ingredient (D) is a polydiorganosiloxane- polyether copolymer represented by the formula:
X_{w},R¹_{3-w}SiO(R²R³SiO)_{d}(R⁴XSiO)_{d′}SiR¹ _{3-w}X_{w} (II)
Wherein X is−R⁵−(OC₂H₄)_{y}(OA)_{z}E)
in which R¹, R², R³, and R⁴ are independently selected from monovalent saturated hydrocarbon radicals and monovalent aromatic hydrocarbon radicals; E is identical or different and selected from hydroxy, alkoxy, and carboxyl; A and R⁵ both denotes an alkylene; w is an integer of 0, 1, or 2, and must be 1 or 2 when d′ is zero; d is an integer of 0 to 200, and d′ is an integer of 0 to 15, where d and d′ are to provide ingredient (D) containing from 5 to 50 percent by mole of polyether per molecule; y and z are independently integer of 0 to 30, the sum of y and z being in the range from 2 to 50.

7. The liquid silicone rubber composition according to claim 6, characterized in that R¹, R², R³, and R⁴ are methyl, R⁵ is propylene or iso-butylene, E is hydroxyl, methoxy, or acetoxy, and A is propylene, iso-propylene, or butylene.

8. The liquid silicone rubber composition according to claim 1, characterized in that ingredient (E) is selected from the group consisting of platinum black, platinum metal on solid supports, chloroplatinic acids, alcohol solutions of chloroplatinic acid, and complexes of chloroplatinic acid with liquid ethylenically unsaturated compounds.

9. The liquid silicone rubber composition according to claim 1, further comprising from 1 to 10 parts by weight of a chain extender as ingredient (F), which is a disiloxane or a low molecular weight polyorganosiloxane containing two silicon-bonded hydrogen atoms at the terminal positions.

10. A method for preparing the liquid silicone rubber composition according to claim 1, comprising mixing ingredients (A) to (E) at ambient temperature.

11. A method for coating a textile, comprising coating the textile with a liquid silicone rubber composition and curing the resulting coating, characterized in that the liquid silicone rubber composition comprises:
(A) 100 parts by weight of a liquid polydiorganosiloxane containing at least two alkenyl radicals in each molecule,
(B) an organohydrogenpolysiloxane containing at least three silicon-bonded hydrogen atoms in each molecule, in an amount that the molar ratio of the total number of the silicon-bonded hydrogen atoms in this ingredient to the total quantity of all alkenyl radicals in ingredient (A) is from 0.5:1 to 20:1,
(C) from 5 to 50 parts by weight of a reinforcing filler, based on the amount of ingredient (A),
(D) from 0.05 to 4.5 parts by weight of a polydiorganosiloxane-polyether copolymer containing from 5 to 50 percent by mole of the polyether, based on 100 parts by weight of the combined weight of ingredients (A), (B), and (C), and
(E) a hydrosilylation catalyst.

12. The method for coating a textile according to claim 11, characterized in that ingredient (A) of the liquid silicone rubber composition is represented by the general formula (I):
R′R″R′″SiO−(R″R′″SiO)ₘ−SiOR′″R″R′ (I)
in which R′ is an alkenyl radical; R″ does not contain ethylenic unsaturation, and is identical or different and individually selected from monovalent saturated hydrocarbon radical and monovalent aromatic hydrocarbon radical; R′″ is R′ or R″; and m represents a degree of polymerization equivalent to that ingredient (A) has a viscosity of at least 0.1 Pa·s at 25 ° C.

13. The method for coating a textile according to claim 11, characterized in that ingredient (A) of the liquid silicone rubber composition is selected from the group consisting of dimethylvinylsiloxy-terminated polydimethylsiloxane, dimethylvinylsiloxy-terminated polymethyl-3,3,3-trifluoropropylslioxane, dimethylvinylsiloxy-terminated dimethylsiloxane-3,3,3-trifluoropropylmethylsiloxne copolymer, and dimethylvinylsiloxy-terminated dimethylsiloxane/methylphenylsiloxane copolymer.

14. The method for forming a coating layer onto a textile according to claim 11, characterized in that ingredient (B) of the liquid silicone rubber composition is selected from the group consisting of trimethylsiloxy-terminated methylhydrogenpolysiloxane, trimethylsiloxy-terminated polydimethylsiloxane-methylhydrogensiloxane, dimethylhydrogensiloxy-terminated dimethylsiloxane-methylhydrogensiloxane coploymers, dimethylsiloxane-methylhydrogensiloxane cyclic copolymers, copolymers composed of (CH₃)₂HSiO_{½} units and SiO _{4/2} units, and copolymers composed of (CH₃)₃SiO_{½} units, (CH₃)₂HSiO_{½} units and SiO _{4/2} units.

15. The method for coating a textile according to claim 11, characterized in that ingredient (C) of the liquid silicone rubber composition is finely divided silica.

16. The method for forming a coating layer onto a textile according to any one of claim 11, characterized in that ingredient (D) of the liquid silicone rubber composition is a polydiorganosiloxane-polyether copolymer represented by the formula:
X_{w}R¹_{3-w}SiO(R²R ³SiO)_{d}(R⁴XSiO)_{d′}SiR¹_{3-w}X_{w} (II)
(wherein X is −R⁵−(OC₂H₄)_{y}(OA)_{z}E)
in which R¹, R², R³, and R⁴ are independently selected from monovalent saturated hydrocarbon radicals and monovalent aromatic hydrocarbon radicals; E is identical or different and selected from hydroxy, alkoxy, and carboxyl; A and R⁵ both denotes an alkylene; w is an integer of 0, 1, or 2, and must be 1 or 2 when d′ is zero; d is an integer of 0 to 200, and d′ is an integer of 0 to 15, where d and d′ are to provide ingredient (D) containing from 5 to 50 percent by mole of polyether per molecule; y and z are independently integer of 0 to 30, the sum of y and z being in the range from 2 to 50.

17. The method for coating a textile according to claim 16, characterized in that R¹, R², R³, and R⁴ are methyl, R⁵ is propylene or iso-butylene, E is hydroxyl, methoxy, or acetoxy, and A is propylene, iso-propylene, or butylene.

18. The method for coating a textile according to claim 11, characterized in that ingredient (E) of the liquid silicone rubber composition is selected from the group consisting of platinum black, platinum metal on solid supports, chloroplatinic acids, alcohol solutions of chloroplatinic acid, and complexes of chloroplatinic acid with liquid ethylenically unsaturated compounds.

19. The method for coating a textile according to claim 11, characterized in that the liquid silicone rubber composition further comprises from 1 to 10 parts by weight of a chain extender as ingredient (F), which is a disiloxane or a low molecular weight polyorganosiloxane containing two silicon-bonded hydrogen atoms at the terminal positions.

20. The method for coating a textile according to claim 11, characterized in that the textile is selected from the group consisting of cotton, polyester and nylon optionally containing elastic fiber.

21. The method for coating a textile in accordance with claim 11 characterized in that the composition is applied by screen printing.

22. A textile coated with a cured composition in accordance with claim 1.

23. Use of a composition in accordance with claim 1 for coating a textile.

24. Use of a composition in accordance with claim 1 to screen print a coating onto a textile material.
